(19) United States
(12) Patent Application Publication
(10) Pub. No.: US 2008/0169992 A1
(43) Pub. Date: Jul. 17, 2008

(54) DUAL-POLARIZATION, SLOT-MODE ANTENNA AND ASSOCIATED METHODS

(75) Inventors: Sean Ortiz, West Melbourne, FL (US); Timothy Durham, Melbourne, FL (US); Griffin Gothard, Satellite Beach, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 11/623,350

(22) Filed: Jan. 16, 2007

(51) Int. Cl. H01Q 13/10; H01P 11/00; H01Q 9/04; H01Q 1/38

(52) U.S. Cl. 343/767; 343/700 MS; 29/600

(57) ABSTRACT

The dual-polarization, slot-mode antenna includes an array of dual-polarization, slot-mode, antenna units carried by a substrate, and each dual-polarization, slot-mode antenna unit includes a plurality of patch antenna elements arranged in spaced apart relation. The substrate is preferably a flexible substrate. Adjacent patch antenna elements of each dual-polarization, slot-mode antenna unit may have respective spaced apart edge portions defining gaps therebetween, and a respective capacitive coupling feed plate may be associated with each gap and overlap the respective spaced apart edge portions of adjacent patch antenna elements of each dual-polarization, slot-mode antenna unit. Each capacitive coupling feed plate may include a feed point.

### FIELD OF THE INVENTION

The present invention relates to the field of communications, and, more particularly, to low profile phased array antennas and related methods.

### BACKGROUND OF THE INVENTION

Existing microwave antennas include a wide variety of configurations for various applications, such as satellite reception, remote broadcasting, or aircraft communication. The desirable characteristics of low cost, light-weight, low profile and mass producibility may be provided in general by printed circuit antennas. The simplest forms of printed circuit antennas are microstrip antennas wherein flat conductive elements are spaced from a single essentially continuous ground element by a dielectric sheet of uniform thickness. An example of a microstrip antenna is disclosed in U.S. Pat. No. 3,995,277 to Olyphant.

The antennas are designed in an array and may be used for communication systems such as identification of friend/foe (IFF) systems, personal communication service (PCS) systems, satellite communication systems, and aerospace systems, which require such characteristics as low cost, light weight, low profile, and low sidelobes.

The bandwidth and directivity capabilities of such antennas, however, can be limiting for certain applications. While the use of electromagnetically coupled microstrip patch pairs can increase bandwidth, obtaining this benefit presents significant design challenges, particularly where maintenance of a low profile and broad bandwidth is desirable. Also, the use of an array of microstrip patches can improve directivity by providing a predetermined scan angle. However, utilizing an array of microstrip patches presents a dilemma. The scan angle can be increased if the array elements are spaced closer together, but closer spacing can increase undesirable coupling between antenna elements thereby degrading performance.

Furthermore, while a microstrip patch antenna is advantageous in applications requiring a conformal configuration, e.g. in aerospace systems, mounting the antenna presents challenges with respect to the manner in which it is fed such that conformality and satisfactory radiation coverage and directivity are maintained and losses to surrounding surfaces are reduced. More specifically, increasing the bandwidth of a phased array antenna with a wide scan angle is conventionally achieved by dividing the frequency range into multiple bands.

One example of such an antenna is disclosed in U.S. Pat. No. 5,485,167 to Wong et al. This antenna includes several pairs of dipole pair arrays each tuned to a different frequency band and stacked relative to each other along the transmission/reception direction. The highest frequency array is in front of the next lowest frequency array and so forth.

This approach may result in a considerable increase in the size and weight of the antenna while creating a Radio Frequency (RF) interface problem. Another approach is to use gimbals to mechanically obtain the required scan angle. Yet, here again, this approach may increase the size and weight of the antenna and result in a slower response time.

Current Sheet Array (CSA) technology offered by Harris Corporation of Melbourne, Fla., the assignee of the present invention, represents the state of the art in broadband, low profile antenna technology. For example, U.S. Pat. No. 6,512,487 to Taylor et al. is directed to a phased array antenna with a wide frequency bandwidth and a wide scan angle by utilizing tightly packed dipole antenna elements with large mutual capacitive coupling. The antenna of Taylor et al. makes use of, and increases, mutual coupling between the closely spaced dipole antenna elements to prevent grating lobes and achieve the wide bandwidth.

A slot version of the CSA has many advantages over the dipole version including the ability to produce vertical polarization at the horizon, a metal aperture coincident with an external ground plane, reduced scattering, and a stable phase center at the aperture. Conformal aircraft antennas frequently require a slot type pattern, but the dipole CSA does not address these applications. Analysis and measurements have shown that the dipole CSA may not meet requirements for vertically polarized energy at the horizon. The dipole CSA may also be limited in wide angle scan performance due to dipole-like element pattern over a ground plane.

### SUMMARY OF THE INVENTION

In view of the foregoing background, it is therefore an object of the present invention to provide a dual-polarization antenna with a slot pattern and improved coupling control to the array elements.

This and other objects, features, and advantages in accordance with the present invention are provided by a dual-polarization, slot-mode antenna including an array of dual-polarization, slot-mode, antenna units carried by a substrate, and each dual-polarization, slot-mode antenna unit comprising a plurality of patch antenna elements arranged in spaced apart relation. The substrate may be a flexible substrate for conformal applications, for example. Adjacent patch antenna elements of each dual-polarization, slot-mode antenna unit may have respective spaced apart edge portions defining gaps therebetween, and a respective capacitive coupling feed plate may be associated with each gap and overlap the respective spaced apart edge portions of adjacent patch antenna elements of each dual-polarization, slot-mode antenna unit. Each capacitive coupling feed plate may include a feed point.

The substrate may comprise a ground plane and a dielectric layer adjacent thereto, and the patch antenna elements may be arranged on the dielectric layer opposite the ground plane. The capacitive coupling feed plates may be between the ground plane and the patch antenna elements. A second dielectric layer may cover the patch antenna elements.

The array of dual-polarization, slot-mode, antenna units preferably defines a plurality of orthogonal antenna slots, such as to provide horizontal and vertical polarizations. Also, an antenna feed structure may be included for each antenna unit and may comprise a plurality of coaxial feed lines, with each coaxial feed line comprising an inner conductor and a tubular outer conductor in surrounding relation thereto. The outer conductors may be connected to the ground plane, and the inner conductors may extend outwardly from ends of respective outer conductors and be connected to respective capacitive coupling feed plates at their feed points. A respective connection bar may electrically connect each outer conductor of the coaxial feed lines of adjacent antenna units.

Each dual-polarization, slot-mode, antenna unit may comprise four square patch antenna elements arranged about a central position with each of the capacitive coupling feed plates extending outwardly from the central position along the gaps defined by respective spaced apart edge portions of adjacent patch antenna elements. The feed point of each capacitive coupling feed plate may be positioned adjacent an outer end thereof.

A method aspect of the invention is directed to a method of making a dual-polarization, slot-mode antenna including forming an array of dual-polarization, slot-mode, antenna units on a substrate, and each dual-polarization, slot-mode antenna unit comprising a plurality of patch antenna elements arranged in spaced apart relation with adjacent patch antenna elements of each dual-polarization, slot-mode antenna unit having respective spaced apart edge portions defining gaps therebetween. The method may also include forming a plurality of capacitive coupling feed plates, each being associated with a respective gap and overlapping the respective spaced apart edge portions of adjacent patch antenna elements of each dual-polarization, slot-mode antenna unit, and each capacitive coupling feed plate including a feed point.

The capacitive feed approach of the present antenna may improve coupling control to the array elements, may improve bandwidth and VSWR over conventional feed approaches, and the antenna may exhibit wide scan performance to 70 degrees, for example. The feed approach may place the feed points at the center of each slot which may improve VSWR, and may improve cross polarization isolation. The antenna may have a mostly metal aperture coincident with the external ground plane, in contrast with the conventional dipole CSA, and which may result in a stable phase center at aperture.

### BRIEF DESCRIPTION OF THE DRAWINGS

FIG. 1 is a schematic plan view illustrating a dual-polarization, slot-mode antenna array in accordance with the present invention.

FIG. 2 is an enlarged plan view illustrating an example of an antenna unit of the array shown in FIG. 1.

FIG. 3 is a schematic side view illustrating the antenna unit of the array shown in FIG. 1.

FIG. 4 is a graph illustrating a simulated VSWR (Bandwidth >6:1) of the dual-polarization, slot-mode antenna array of FIG. 1.

FIG. 5 is a graph illustrating measured gain at 0 and 70 degree scan angles of a four-by-two array antenna in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

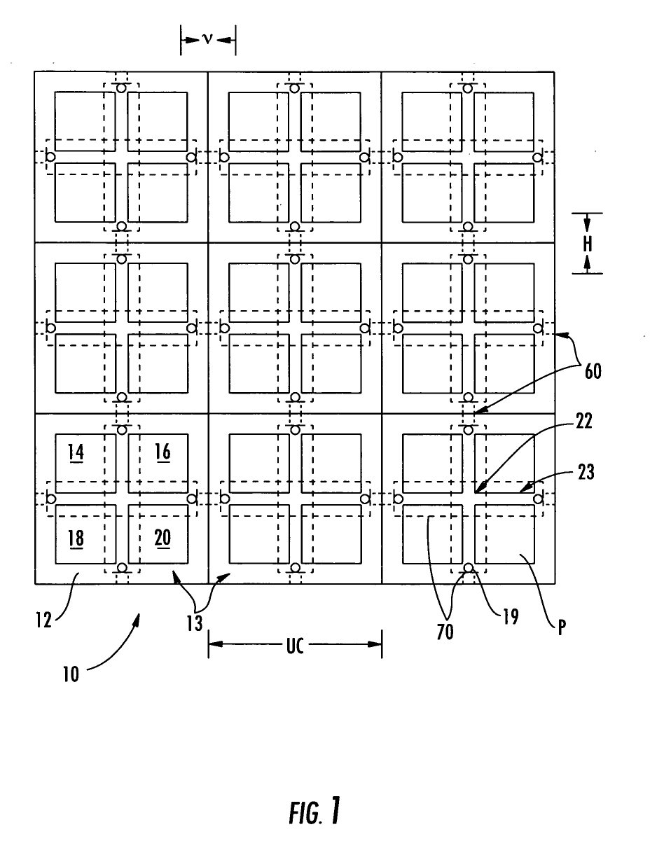

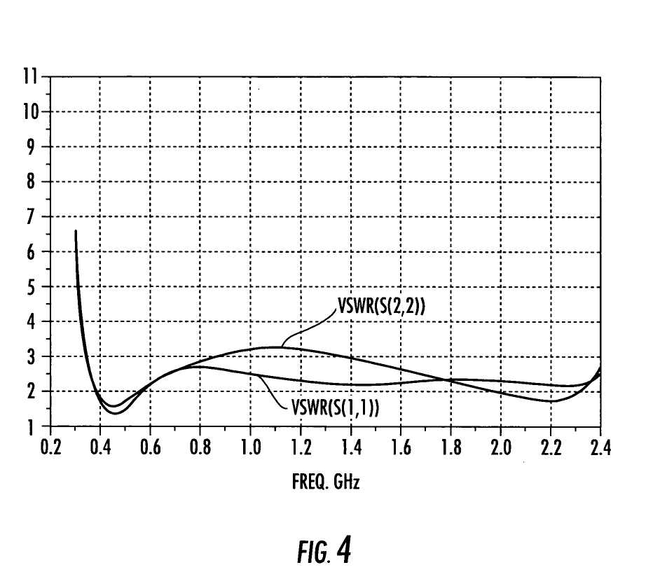

Referring initially to FIGS. 1-3, a dual polarization, slot-mode antenna 10 according to the invention will now be described. The antenna 10 includes a substrate 12 having a ground plane 26 and a dielectric layer 24 adjacent thereto, and at least one antenna unit 13 or unit cell UC carried by the substrate. Preferably, a plurality of antenna units 13 are arranged in an array. As shown in FIG. 1, the antenna 10, for example, includes nine antenna units 13. Each antenna unit 13 includes a plurality of antenna patches P or elements, e.g. four adjacent antenna patches 14, 16, 18, 20, arranged in spaced apart relation from one another about a central feed position 22 on the dielectric layer 24 opposite the ground plane 26.

Adjacent patch antenna elements P of each dual-polarization, slot-mode antenna unit 13 illustratively have respective spaced apart edge portions defining gaps 23 therebetween. A respective capacitive coupling feed plate 70 is associated with each gap 23 and overlaps the respective spaced apart edge portions of adjacent patch antenna elements P of each dual-polarization, slot-mode antenna unit 13. Each capacitive coupling feed plate 70 includes a feed point 19. As shown in the illustrated embodiment, the capacitive coupling feed plates 70 may be between the ground plane 26 and the patch antenna elements P. A second dielectric layer 28 may cover the patch antenna elements P.

Preferably, the antenna elements P are fed with 0/180° phase across their respective gaps to excite a slot mode. The phasing of the element excitations also provides dual polarization, as would be appreciated by the skilled artisan.

The array of dual-polarization, slot-mode, antenna units 13 preferably defines a plurality of orthogonal slots identified as horizontal H and vertical V antenna slots compatible with respective vertical and horizontal polarizations. Also, an antenna feed structure 30 is illustratively included for each antenna unit 13 and comprises a plurality of coaxial feed lines 32. Each coaxial feed line 32 comprises an inner conductor 42 and a tubular outer conductor 44 in surrounding relation thereto, with the outer conductors being illustratively connected to the ground plane 26. The inner conductors 42 extend outwardly from ends of respective outer conductors and are connected to respective capacitive coupling feed plates 70 at the feed points 19. A respective connection bar 60 electrically connects each outer conductor 44 of the coaxial feed lines 32 of adjacent antenna units 13. The connection bars 60 at the periphery of the array are illustratively connected to the ground plane 26.

Each of the capacitive coupling feed plates 70 extends outwardly from the central position 22 along the gaps 23 defined by respective spaced apart edge portions of adjacent patch antenna elements P. The feed points 19 of each of the capacitive coupling feed plates 70 are illustratively positioned adjacent an outer end thereof, e.g. outside of the area defined by the antenna patches P.

The ground plane 26 extends laterally outwardly beyond a periphery of the antenna units 13, and the coaxial feed lines 32 diverge outwardly from contact with one another upstream from the central feed position 22. The antenna 10 may also include at least one hybrid circuit (not shown) connected to the antenna feed structure 30. The hybrid circuit controls, receives and generates the signals to respective antenna elements 14, 16, 18, 20 of the antenna units 13, as would be appreciated by those skilled in the art.

The dielectric layer 24 preferably has a thickness in a range of about ½ an operating wavelength near the top of the operating frequency band of the antenna 10, and the upper or impedance matching dielectric layer 28 may be provided over the antenna units 13. This impedance matching dielectric layer 28 may also extend laterally outwardly beyond a periphery of the antenna units 13. The use of the extended substrate 12 and extended impedance matching dielectric layer 28 may result in an increased antenna bandwidth. The substrate 12 may be flexible in some embodiments so that it can be conformally mounted to a rigid surface, such as the nose-cone of an aircraft or spacecraft, for example.

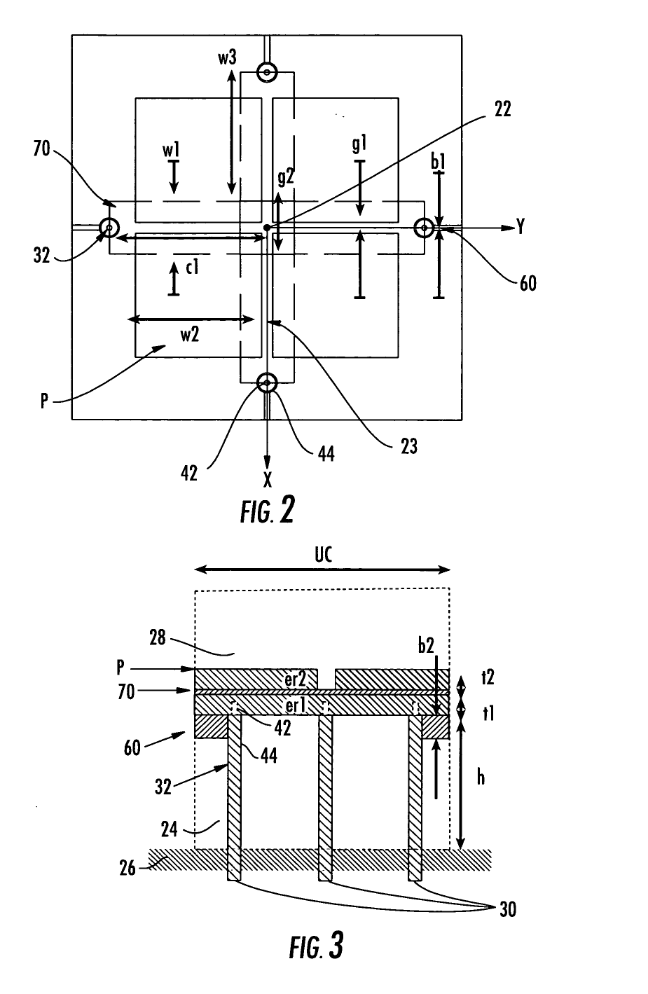

Referring specifically to FIG. 2, a non-limiting example of an antenna unit 13 may include the following dimensions and/or dimension ranges: UC=2.0″, h=2.0″, t1=0.03″, t2=0.01″.

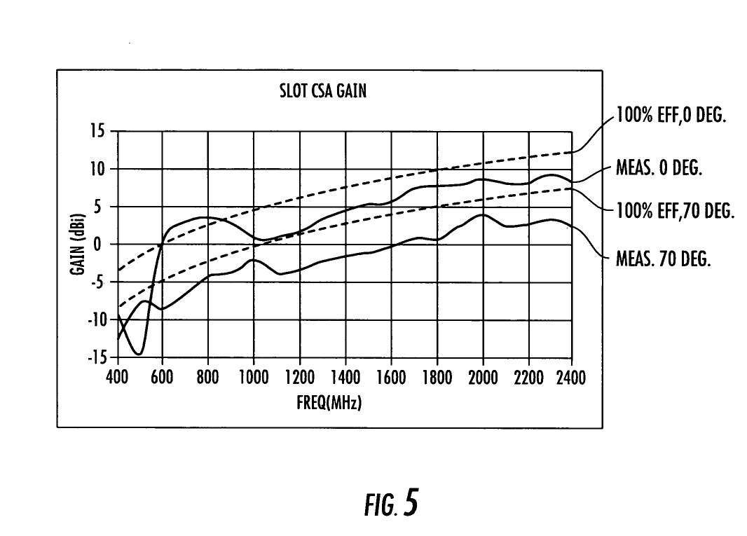

FIG. 4 is a graph illustrating a simulated VSWR (Bandwidth >6:1) of the dual-polarization, slot-mode antenna array of FIG. 1, where the VSWR(S(2,2)) trace represents the VSWR of the antenna matched to a 50 Ohm load, whereas the VSWR(S(1,1)) trace represents the VSWR after a two step impedance transformer to a 50 Ohm load. FIG. 5 is a graph illustrating measured gain at 0 and 70 degree scan angles of a four-by-two circularly polarized array. The dotted lines represent the maximum gain available from a uniformly illuminated aperture of the same area as the four-by-two array. The two solid curves represent the measured data for the two scan cases of 0 degrees and 70 degrees from boresight.

The antenna array 10 has improved coupling control to the array elements P. Thus, an antenna array 10 with a wide frequency bandwidth and a wide scan angle is obtained by utilizing the antenna elements 14, 16, 18, 20 of each slot-mode antenna unit 13 having capacitive coupling feed plates 70. The capacitive feed approach may improve bandwidth and VSWR over conventional feed approaches. The feed approach may place the feed points 19 at the center of each slot H, V which may improve VSWR, and may improve cross polarization isolation. The antenna 10 may have a mostly metal aperture coincident with the external ground plane 26 in contrast with the conventional dipole CSA and which may result in a stable phase center at aperture.

A method aspect of the invention is directed to a method of making a dual-polarization, slot-mode antenna 10 including forming an array of dual-polarization, slot-mode, antenna units 13 on a dielectric layer 24, and each dual-polarization, slot-mode antenna unit comprising a plurality of patch antenna elements P arranged in spaced apart relation with adjacent patch antenna elements of each dual-polarization, slot-mode antenna unit having respective spaced apart edge portions defining gaps 23 therebetween. The method may also include forming a plurality of capacitive coupling feed plates 70 each being associated with a respective gap 23 and overlapping the respective spaced apart edge portions of adjacent patch antenna elements P of each dual-polarization, slot-mode antenna unit 13, and each capacitive coupling feed plate including a feed point 19.

The ground plane 26 and the dielectric layer 24 adjacent thereto may define the substrate 12, and forming the array may include arranging the patch antenna elements P on the dielectric layer 24 opposite the ground plane. The capacitive coupling feed plates 70 may be provided between the ground plane 26 and the patch antenna elements P. The array of dual-polarization, slot-mode, antenna units 13 preferably defines a plurality of orthogonal antenna slots.

The method may also include providing an antenna feed structure 30 for each antenna unit 13 and comprising a plurality of coaxial feed lines 32, with each coaxial feed line comprising an inner conductor 42 and a tubular outer conductor 44 in surrounding relation thereto. The outer conductor may be connected to the ground plane 26, and the inner conductors may extend outwardly from ends of respective outer conductors and be connected to respective capacitive coupling feed plates 70 at the feed point 19. Furthermore, a respective connection bar 60 may electrically connect respective outer conductors 44 of coaxial feed lines of adjacent antenna units.

The antenna 10 may have a 6:1 bandwidth for 3:1 VSWR, and may achieve a scan angle of ±70 degrees. Thus, a lightweight patch array antenna 10 according to the invention with a wide frequency bandwidth and a wide scan angle is provided. Also, the antenna 10 is flexible and can be conformally mountable to a surface, such as an aircraft.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A dual-polarization, slot-mode antenna comprising:
a substrate;
an array of dual-polarization, slot-mode, antenna units carried by said substrate, and each dual-polarization, slot-mode antenna unit comprising a plurality of patch antenna elements arranged in spaced apart relation;
adjacent patch antenna elements of each dual-polarization, slot-mode antenna unit having respective spaced apart edge portions defining gaps therebetween; and
a plurality of capacitive coupling feed plates each being associated with a respective gap and overlapping the respective spaced apart edge portions of adjacent patch antenna elements of each dual-polarization, slot-mode antenna unit;
each capacitive coupling feed plate including a feed point.

2. The antenna according to claim 1 wherein said substrate comprises a ground plane and a dielectric layer adjacent thereto; and wherein the patch antenna elements are arranged on said dielectric layer opposite said ground plane.

3. The antenna according to claim 2 wherein the capacitive coupling feed plates are between the ground plane and the patch antenna elements.

4. The antenna according to claim 2 further comprising a second dielectric layer covering the patch antenna elements.

5. The antenna according to claim 1 wherein said array of dual-polarization, slot-mode, antenna units defines a plurality of orthogonal antenna slots.

6. The antenna according to claim 2 further comprising an antenna feed structure for each antenna unit and comprising a plurality of coaxial feed lines, each coaxial feed line comprising an inner conductor and a tubular outer conductor in surrounding relation thereto, said outer conductors being connected to said ground plane, said inner conductors extending outwardly from ends of respective outer conductors and being connected to respective capacitive coupling feed plates at feed points thereof.

7. The antenna according to claim 6 further comprising a plurality of connection bars each electrically connecting respective outer conductors of coaxial feed lines of adjacent antenna units.

8. The antenna according to claim 1 wherein each dual-polarization, slot-mode, antenna unit comprises four square patch antenna elements arranged about a central position; and wherein each of the capacitive coupling feed plates extends outwardly from the central position along the gaps defined by respective spaced apart edge portions of adjacent patch antenna elements.

9. The antenna according to claim 8 wherein the feed point of each capacitive coupling feed plate is positioned adjacent an outer end thereof.

10. The antenna according to claim 1 wherein said substrate is flexible.

11. A dual-polarization, slot-mode antenna comprising:
a substrate comprising a ground plane and a dielectric layer adjacent thereto; and
an array of dual-polarization, slot-mode, antenna units carried by said substrate and defining a plurality of orthogonal antenna slots;
each dual-polarization, slot-mode antenna unit comprising four patch antenna elements arranged in spaced apart relation about a central position and on said dielectric layer opposite said ground plane;
adjacent patch antenna elements of adjacent dual-polarization, slot-mode antenna units having respective spaced apart edge portions defining gaps therebetween; and
a respective capacitive coupling feed plate being associated with each gap and overlapping the respective spaced apart edge portions of adjacent patch antenna elements of each dual-polarization, slot-mode antenna unit;
each capacitive coupling feed plate include a feed point.

12. The antenna according to claim 11 wherein the capacitive coupling feed plates are between the ground plane and the patch antenna elements.

13. The antenna according to claim 11 further comprising a second dielectric layer covering the patch antenna elements.

14. The antenna according to claim 11 further comprising an antenna feed structure for each antenna unit and comprising a plurality of coaxial feed lines, each coaxial feed line comprising an inner conductor and a tubular outer conductor in surrounding relation thereto, said outer conductors being connected to said ground plane, said inner conductors extending outwardly from ends of respective outer conductors and being connected to respective capacitive coupling feed plates at feed points thereof.

15. The antenna according to claim 14 further comprising a plurality of connection bars each electrically connecting respective outer conductors of coaxial feed lines of adjacent antenna units.

16. The antenna according to claim 11 wherein each of the capacitive coupling feed plates extends outwardly from the central position along the gaps defined by respective spaced apart edge portions of adjacent patch antenna elements.

17. The antenna according to claim 16 wherein the feed point of each capacitive coupling feed plate is positioned adjacent an outer end thereof.

18. A method of making a dual-polarization, slot-mode antenna comprising:
forming an array of dual-polarization, slot-mode, antenna units on a substrate, and each dual-polarization, slot-mode antenna unit comprising a plurality of patch antenna elements arranged in spaced apart relation with adjacent patch antenna elements of each dual-polarization, slot-mode antenna unit having respective spaced apart edge portions defining gaps therebetween; and
forming a plurality of capacitive coupling feed plates each being associated with a respective gap and overlapping the respective spaced apart edge portions of adjacent patch antenna elements of each dual-polarization, slot-mode antenna unit, and each capacitive coupling feed plate including a feed point.

19. The method according to claim 18 wherein the substrate comprises a ground plane and a dielectric layer adjacent thereto; and wherein forming the array comprises arranging the patch antenna elements on the dielectric layer opposite the ground plane.

20. The method according to claim 19 wherein the capacitive coupling feed plates are formed between the ground plane and the patch antenna elements.

21. The method according to claim 18 further comprising covering the patch antenna elements with a second dielectric layer.

22. The method according to claim 18 wherein the array of dual-polarization, slot-mode, antenna units defines a plurality of orthogonal antenna slots.

23. The method according to claim 19 further comprising providing an antenna feed structure for each antenna unit and comprising a plurality of coaxial feed lines, each coaxial feed line comprising an inner conductor and a tubular outer conductor in surrounding relation thereto, the outer conductors being connected to the ground plane, the inner conductors extending outwardly from ends of respective outer conductors and being connected to respective capacitive coupling feed plates at the feed point.

24. The method according to claim 23 further comprising electrically connecting respective outer conductors of coaxial feed lines of adjacent antenna units with a respective connection bar.

25. The method according to claim 18 wherein each dual-polarization, slot-mode, antenna unit comprises four square patch antenna elements arranged about a central position; and wherein each of the capacitive coupling feed plates extends outwardly from the central position along the gaps defined by respective spaced apart edge portions of adjacent patch antenna elements.

26. The method according to claim 25 wherein the feed point of each capacitive coupling feed plate is positioned adjacent an outer end thereof.
